(19) United States
(12) Patent Application Publication
(10) Pub. No.: US 2014/0094319 A1
(43) Pub. Date: Apr. 3, 2014

(54) METHOD FOR MULTI MACHINE CRITICAL MEMORY VERSIONING, MIGRATION AND REPLICATION

(71) Applicant: WMS GAMING, INC., Waukegan, IL (US)

(72) Inventors: Ranjan Dasgupta, Naperville, IL (US); Faith R. LeBrun Jennings, Chicago, IL (US); Nagaraju Magati, Buffalo Grove, IL (US); Kyle G. Nyenhuis, Riverside, IL (US); Mark J. Saletnik, Palatine, IL (US); Jorge Luis Shimabukuro, Las Vegas, NV (US)

(73) Assignee: WMS GAMING, INC., Waukegan, IL (US)

(21) Appl. No.: 13/786,812

(22) Filed: Mar. 6, 2013

Related U.S. Application Data
(60) Provisional application No. 61/707,352, filed on Sep. 28, 2012.

(51) Int. Cl. G07F 17/32

(52) U.S. Cl. CPC G07F 17/3227
USPC 463/43

(57) ABSTRACT

A notification that the data in the critical memory is to be accessed may be received. The data in the critical memory may be reviewed to determine if a version update is required. It may be determined if the data in the critical memory requires a version update. If the data requires a version update, a related version algorithm may be used to retrieve the data from the critical memory.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE DISCLOSURE

The present disclosure relates generally to gaming apparatus and methods and, more particularly, to critical memory in gaming devices.

### BACKGROUND OF THE DISCLOSURE

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

Updating gaming machines has often meant replacing entire chips in order to preserve critical data such as pay tables. As gaming machines have become more prevalent in increasingly disparate and remote locations, replacing chips has become more of a challenge. While updating software remotely has been known, remotely updating software in a gaming machine that has critical data has proven to be a challenge.

In addition, there may be various versions of gaming applications. Each application may look for the data to be in a particular format and this format may change with each version. If the format of the data is not changed, later versions may improperly read the data leading to potentially harmful situations to the players and the gaming establishment.

### SUMMARY OF THE DISCLOSURE

According to one aspect of the present disclosure, a gaming system comprises a method of parsing data stored according to a plurality of versions in critical memory in a gaming device is disclosed. In one embodiment, a method may receive a notification that the data in the critical memory is to be accessed. The data in the critical memory may be reviewed to determine if a version update is required. It may be determined if the data in the critical memory requires a version update. If the data requires a version update, a related version algorithm may be used to retrieve the data from the critical memory.

According to another aspect of the disclosure, a dedicated computer-implemented method in a gaming system comprises a processor, a memory and an input-output circuit. The processor may be physically configured to perform a method of parsing data stored according to a plurality of versions in critical memory in a gaming device.

According to yet another aspect of the disclosure, computer readable storage media is physically configured with instructions for directing a gaming system to perform the above methods.

Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic illustration of a gaming system according to an embodiment of the present disclosure.

FIG. 2 is a schematic illustration of an online gaming server usable in the gaming system of FIG. 1.

FIG. 3 is a schematic illustration of a computational device usable in the gaming system of FIG. 1.

FIG. 4a is a perspective view of a free-standing gaming machine usable in the gaming system of FIG. 1.

FIG. 4b is a schematic illustration of architecture for the gaming machine of FIG. 4a.

FIG. 5 is a perspective view of a handheld gaming machine usable in the gaming system of FIG. 1.

FIG. 6a is an image of an exemplary registration interface for a gaming service displayed on an output device of a client, according to an embodiment of the present disclosure.

FIG. 6b is an image of an exemplary gameplay interface for a gaming service displayed on an output device of a client, according to an embodiment of the present disclosure.

FIG. 7 is a flowchart for an algorithm for parsing data stored according to a plurality of versions in critical memory that corresponds to instructions executed by a controller in accord with at least some aspects of the disclosed concepts.

FIG. 8 is an illustration of items in three versions of a memory.

FIG. 9 is a flowchart for an algorithm for distributing critical memory that corresponds to instructions executed by a controller in accord with at least some aspects of the disclosed concepts.

While the disclosure is susceptible to various modifications and alternative forms, specific embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the disclosure as defined by the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino game formats. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

### Overall Network

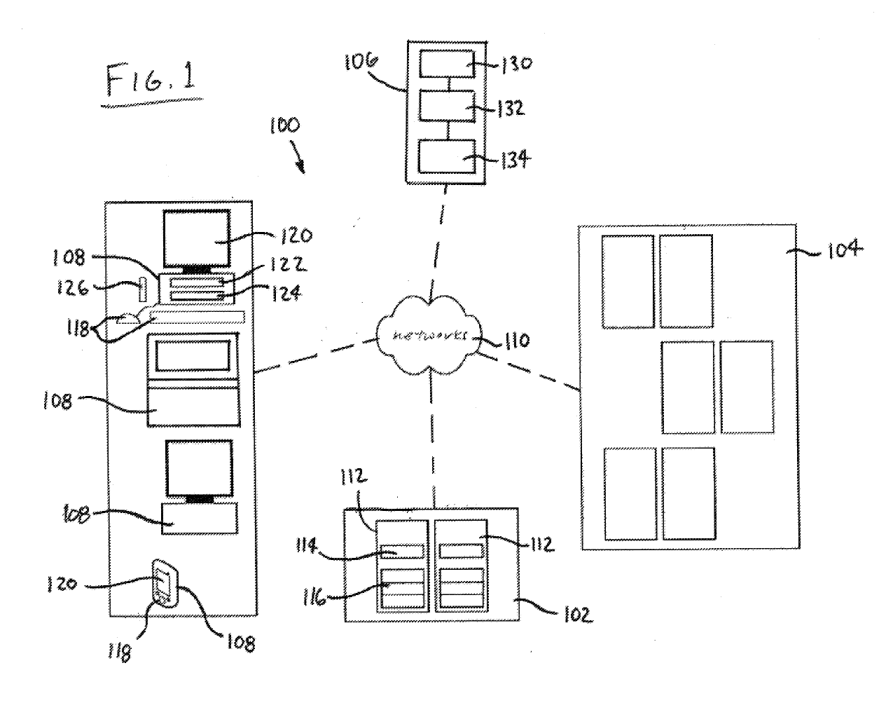

Referring to FIG. 1, one exemplary embodiment of a gaming system 100 is provided. In general, the gaming system 100 may be used to manage and/or facilitate certain interactions between gaming service providers, players or registrants of games provided by the gaming service providers, as well as social and/or virtual communities with which the players or registrants may be affiliated, associated and/or registered. As shown, the gaming system 100 includes at least one or more gaming servers 102, one or more community servers 104, one or more account servers 106, and one or more client devices 108, as well as one or more networks 110 electronically communicating information between each of the gaming servers 102, community servers 104, account servers 106, and clients 108. More specifically, the one or more networks 110 enable users or registrants at the client devices 108 to access gaming services from the gaming servers 102, social networks and/or virtual communities from the community servers 104, and account services from the account servers 106.

While each component of the gaming system 100 is shown as a separate and distinct element connected via a communications network 110, some of functions discussed herein as being performed by one component may be performed by other components. For example, the gaming servers 102 may also be configured to gather and store biometric data, record and store online gaming activity, transfer shared files between player accounts, etc. The components shown may all be contained in one device, but some, or all, may be included in, or performed by multiple devices, or other configurations not shown.

Furthermore, the gaming system 100 may be implemented as software, hardware, any combination thereof, or other forms not listed. For example, any of the network components (e.g., the gaming servers 102, community servers 104, account servers 106, client devices 108, etc.) may include hardware and machine-readable media including instructions for performing the operations described herein. Machine-readable media includes any mechanism that provides (i.e., stores and/or transmits) information in a form readable by a machine (e.g., a gaming machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

Thus, in some embodiments, the clients 108 may be dedicated gaming devices such as a gaming device provided in a casino. The gaming device may execute the gaming computer code locally or the gaming device may be a thought of as a node on a network where one or more servers (which may be local or remote) may execute code and the video signal may be communicated to the gaming device. In other embodiments, the gaming device may be a computing device in a user's home such as a personal computer. The processor in the computing device may be physically configured to execute the code or the personal computer. In other embodiments, the computing device may be thought of as a node on a network where a server is physically configured according to the gaming computing instructions. In yet another embodiment, the gaming device may be a portable computing device. The portable computing device may be physically configured to execute the gaming code or the portable computing device may be in communication with a server that executes some or all of the gaming code and communicates images to be displayed. In all the embodiments, the gaming device may communicate with a central authority that may track game play, awards, likes, dislikes, etc., assuming sufficient permission is obtained. The communication may be wired or wireless and the communication may be secured in a manner to ensure the integrity of the game and the player private information is maintained. In addition, the game may operate on a variety of platforms, from an operating system on a PC to a social media application on a portable computing device platform, to a gaming console platform.

### Gaming Servers

As shown in FIG. 1, the gaming system 100 includes one or more gaming servers 102 which are managed or operated by gaming service providers and configured to enable registered players or registrants to participate in any one or more of a variety of gaming services over the one or more networks 110 provided. Accordingly, the gaming servers 102 may be configured to manage a plurality of databases including, for example, a registrant database and a gaming service database, among other things. Moreover, as is generally held in the art, each gaming server 102 may include one or more computational devices 112 having at least one processor 114 and at least one memory 116 for storing instructions configured to cause the one or more processors 114 of the gaming server 102 to perform one or more preprogrammed functions or operations.

The one or more gaming servers may be located proximately to or remotely from the clients 108. When located proximately, such as at a land-based casino location, the one or more gaming servers 102 may be considered to be part of a casino server. Alternatively, when located remotely, the one or more gaming servers 102 may be considered to be an on-line gaming server. Furthermore, the gaming system may include both one or more casino servers and one or more on-line gaming servers.

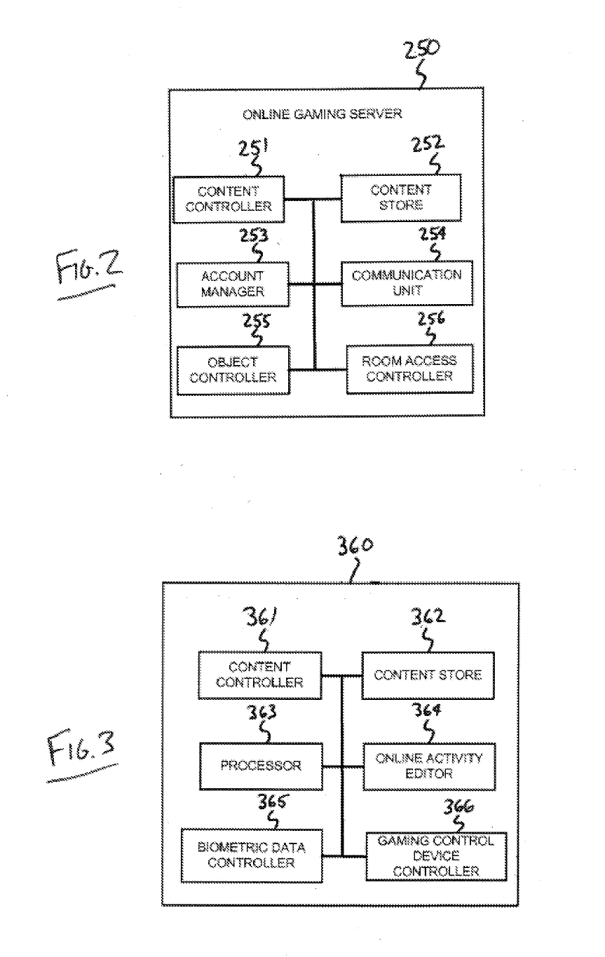

An example of an on-line gaming server 250 is schematically illustrated in greater detail in FIG. 2. The online gaming server 250 may be configured to control wagering game content, provide random numbers, and communicate wagering game information, account information, and other information to and from the clients 108. The online gaming server 250 may include a content controller 251 configured to manage and control content for the presentation of content on the clients 108. For example, the content controller 251 may generate game results (e.g., win/loss values), including win amounts, for games played on the clients 108, and communicate the game results to the clients 108. The content controller 251 may also generate random numbers and provide them to the client 108 so that the clients 108 may generate game results.

The online gaming server 250 may also include a content store 252 configured to contain content to present on the clients 108. The online gaming server 250 may also include an account manager 253 configured to control information related to player accounts. For example, the content controller 251 may communicate wager amounts, game results amounts (e.g., win amounts), award game amounts, etc., to the account server 106. The online gaming server 250 may also include a communication unit 254 configured to communicate information to the clients 108 and to communicate with other systems, devices and networks. For example, the communication unit 254 may track and communicate with community wagering game servers, account servers, community servers, social networking servers, file sharing servers, etc. The online gaming server 250 may also include an object controller 255 configured to control position, movements, actions, functions, etc. of online gaming objects. The online gaming server 250 may also include a room access controller 256 configured to control access to online gaming venue rooms, including security and access levels based on player settings, player status, etc.

### Community Servers/Networks

The community servers 104 of FIG. 1 may be similarly managed or operated by social networks and include virtual communities, public forums, blogs, and the like. Such community servers 104 typically include databases for not only managing the web-based interfaces associated with one or more online communities, but also for managing databases of information pertaining to registrants or members as well as corresponding member profiles, registration information, user preferences, and the like. As with the gaming servers 102, services of the community servers 104 are accessible to registrants via client devices 108 and through the one or more networks 110 interconnecting the client 108 to the community servers 104. Specifically, the network 110 may take the form of a local area network (LAN), a wireless cellular data network, a wide area network (WAN) such as the internet, or any other suitable network or combination of networks enabling local and/or remote communications between the gaming servers 102, community servers 104, account servers 106, and the clients 108.

### Account Servers

The account server 106 may be configured to control user related accounts accessible via wagering game networks, which may include land-based or on-line casino networks and social networks. The account server 106 may store and track player information, such as identifying information (e.g., avatars, screen name, account identification numbers, etc.) or other information like financial account information, social contact information, etc. The account server 106 may contain accounts for social contacts referenced by the player account. The account server 106 may also provide auditing capabilities, according to regulatory rules, and track the performance of players, machines, and servers.

As schematically illustrated in FIG. 1, the account server 106 may include an account controller 130 configured to control information for a player's account, an account store 132 configured to store information for a player's account, and a player preferences settings 134 configured to store settings associated with actions, skins, behaviors, multi-media files, music, and other information with a player account's indicated expressions of emotion, and/or a system imposed expression of an emotion, for an avatar or other object within the online gaming venue. The player preferences settings 134 may communicate information to the object controller 255 to apply the information stored in the settings to an avatar object associated with the player account.

### Client Devices

As depicted in the embodiment of FIG. 1, the client devices or clients 108 may take any one of a plurality of forms including a mobile device, a cellular phone, a smartphone, a tablet device, a laptop computer, a desktop computer, a stationary gaming machine, a portable gaming machine, or any other computational device having at least one input device 118 and at least one output device 120. The input device 118 may include any one or more of a mouse, a keypad, a keyboard, a touchpad, a touchscreen, a microphone, a camera, and any other device enabling the registrant to input information. The output device 120 may include any one or more of a monitor, a display screen, a touchscreen, a speaker, or any other output device enabling a gaming service to be presented to the registrant. The client device 108 also includes one or more processors 122 and at least one memory 124 for storing instructions configured to cause the processor 122 to, among other things, facilitate and/or provide an interface through which a registrant may participate in one or more gaming services sourced by the gaming servers 102 using the input devices 118 and output devices 120. Correspondingly, the client device 108 additionally includes at least one communication device 126, such as a modem, a receiver, a transmitter, a transceiver, a network card, an Ethernet card, or any other communication device having wired and/or wireless connectivity with the gaming servers 102 through the one or more networks 110.

The clients 108 may communicate with external systems (in a wired or wireless manner) such that each client 108 operates as a “thin client,” having relatively less functionality, a “thick client,” having relatively more functionality, or through any range of functionality therebetween (e.g., a “rich client”). When configured as a “thin client,” the client 108 may operate primarily as a display device to display the results of gaming outcomes processed externally, for example, on a server, which may be an external computing device or a “cloud” of computing devices that communicate and work together. In this “thin client” configuration, the external server executes game code and determines game outcomes (e.g., with a random number generator), while a controller on board the client 108 processes display information to be displayed on the display(s) 120.

In an alternative “rich client” configuration, the external server may determine game outcomes while the controller on board the client 108 executes game code and processes display information to be displayed on the display(s) 120. In yet another alternative “thick client” configuration, a controller on board the client 108 executes game code, determines game outcomes, and processes display information to be displayed on the display(s) 120. Numerous alternative configurations are possible such that the aforementioned and other functions may be performed onboard or external to the client 108 as may be necessary for particular applications. It should be understood that the clients 108 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

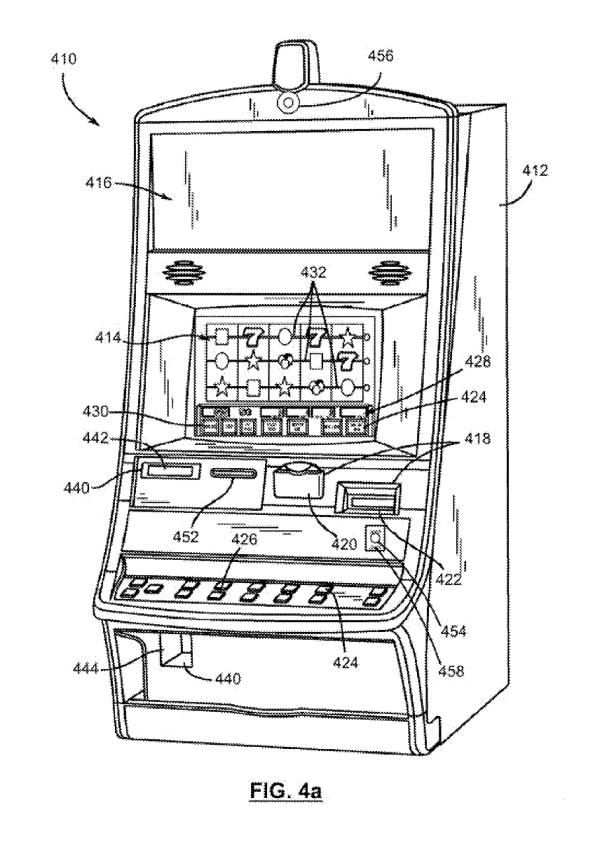

An embodiment of a client 108 is schematically illustrated as a computational device 360 in FIG. 3. The computational device 360 may be configured to present wagering games and receive and transmit information to control and present online wagering games. The computational device 360 may include a content controller 361 configured to manage and control content and presentation of online gaming venue content on the computational device 360. The computational device 360 may also include a content store 362 configured to contain content to present on the computer system 360. The computational device 360 may also include a processor 363 configured to process wagering game content, present online wagering game objects, control gaming devices, etc.

The computational device 360 may also include an online activity editor 364 configured to record, modify, and share recorded online gaming activity. The online activity editor 364 may be further configured to add comments, text, pictures and other multi-media modifications to the recorded online gaming activity files. The online activity editor 364 may share the recorded online gaming activity with other player accounts. The computational device 360 may also include a biometric data controller 365 configured to detect biometric data from one or more sensors and equipment attached to the computational device and transfer the data to the object controller to express one or more indications of emotions by a player account. The computer system 360 may also include a gaming control device controller 366 configured to detect and control devices, including a gaming pad, custom player control devices, login devices, etc. The gaming pad, for example, may be configured to move an avatar within the online gaming venue in a very fluid motion, much more fluidly than possible with a standard keyboard.

### Casino Gaming Machine

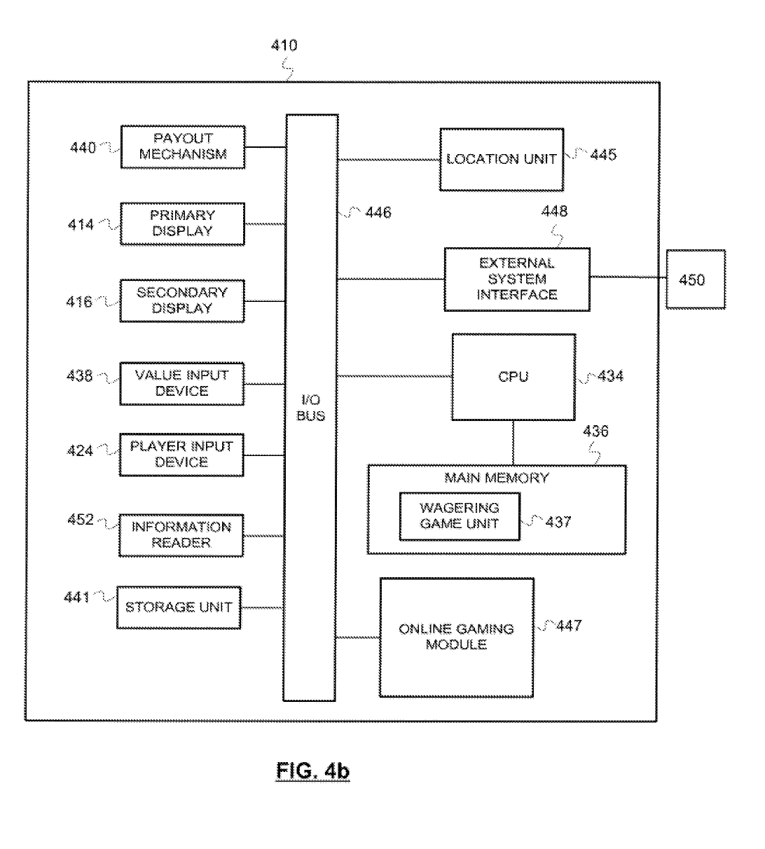

One type of client 108 may be a gaming machine 410 configured for use in a gaming establishment such as a casino, as illustrated in FIGS. 4a and 4b. The gaming machine 410 may be any type of gaming machine and may have varying structures and methods of operation. For example, the gaming machine 410 may be an electromechanical gaming machine configured to play mechanical slots, or it may be an electronic gaming machine configured to play a video casino game, such as slots, keno, poker, blackjack, roulette, etc.

The gaming machine 410 may include a housing 412 and may include input devices, including a value input device 418 and a player input device 424. For output, the gaming machine 410 may include a primary display 414 for displaying information about the wagering game. The primary display 414 may also display information about an award wagering game and a progressive wagering game. The gaming machine 410 may also include a secondary display 416 for displaying game events, game outcomes, and/or signage information. While these typical components found in the gaming machine 410 are described below, it should be understood that numerous other elements may exist and may be used in any number of combinations to create various forms of a gaming machine 410.

The value input device 418 may be provided in many forms, individually or in combination, and is preferably located on the front of the housing 412. The value input device 418 may receive currency and/or credits that may be inserted by a player. The value input device 418 may include a coin acceptor 420 for receiving coin currency (see FIG. 4a). Alternatively, or in addition, the value input device 418 may include a bill acceptor 422 for receiving paper currency. Furthermore, the value input device 418 may include a ticket reader, or barcode scanner, for reading information stored on a credit ticket, a card, or other tangible portable credit storage device. The credit ticket or card may also authorize access to a central account, which can transfer money to the gaming machine 410.

The player input device 424 may include a plurality of push buttons 426 on a button panel for operating the gaming machine 410. In addition, or alternatively, the player input device 424 may include a touch screen 428 mounted by adhesive, tape, or the like over the primary display 414 and/or secondary display 416. The touch screen 428 may include soft touch keys 430 denoted by graphics on the underlying primary display 414 and may be used to operate the gaming machine 410. The touch screen 428 may provide players with an alternative method of input. A player may enable a desired function either by touching the touch screen 428 at an appropriate touch key 430 or by pressing an appropriate push button 426 on the button panel. The touch keys 430 may be used to implement the same functions as push buttons 426. Alternatively, the push buttons 426 may provide inputs for one aspect of operating the game, while the touch keys 430 may allow for input needed for another aspect of the game. In some embodiments, a physical player sensor 456 may also be included. The physical player sensor 456 may be a camera or a biometric sensor or a motion detecting device. The physical player sensor 456 may be used to provide inputs to the game, such as images, selection motions, biometric data and other physical information.

The various components of the gaming machine 410 may be connected directly to, or contained within, the housing 412, as shown in FIG. 4a, or may be located outboard of the housing 412 and connected to the housing 412 via a variety of different wired or wireless connection methods. Thus, the gaming machine 410 may include these components whether housed in the housing 412, or outboard of the housing 412 and connected remotely.

The operation of the basic wagering game may be displayed to the player on the primary display 414. The primary display 414 may also display the award game associated with the basic wagering game. The primary display 414 may take the form of a cathode ray tube (CRT), a high resolution LCD, a plasma display, an LED, or any other type of display suitable for use in the gaming machine 410. As shown, the primary display 414 may include the touch screen 428 overlaying the entire display (or a portion thereof) to allow players to make game-related selections. Alternatively, the primary display 414 of the gaming machine 410 may include a number of mechanical reels to display the outcome in visual association with at least one payline 432. In the illustrated embodiment, the gaming machine 410 is an “upright” version in which the primary display 414 is oriented vertically relative to the player. Alternatively, the gaming machine may be a “slant-top” version in which the primary display 414 may be slanted at about a thirty-degree angle toward the player of the gaming machine 410.

A player may begin play of the basic wagering game by making a wager via the value input device 418 of the gaming machine 410. The value wagered may have a real money value or may be a virtual value that is not redeemable in cash. A player may select play by using the player input device 424, via the buttons 426 or the touch screen keys 430. The basic game may include of a plurality of symbols arranged in an array, and may include at least one payline 432 that indicates one or more outcomes of the basic game. Such outcomes may be randomly selected in response to the wagering input by the player. At least one of the plurality of randomly-selected outcomes may be a start-award outcome, which may include any variations of symbols or symbol combinations triggering a award game.

In some embodiments, the gaming machine 410 may also include a player information reader 452 that allows for identification of a player by reading a card 454 with player information 458 indicating his or her true identity. The player information reader 452 is shown in FIG. 4a as a card reader, but may take on many forms including a ticket reader, bar code scanner, RFID transceiver or computer readable storage medium interface. Currently, identification 458 may be generally used by casinos for rewarding certain players with complimentary services or special offers. For example, a player may be enrolled in the gaming establishment's loyalty club and may be awarded certain complimentary services as that player collects points in his or her player-tracking account. The player may insert his or her card 454 into the player information reader 452, which allows the casino's computers to register that player's wagering at the gaming machine 410. The gaming machine 410 may use the secondary display 416 or other dedicated player-tracking display for providing the player with information about his or her account or other player-specific information. Also, in some embodiments, the information reader 452 may be used to recall or restore game assets that the player achieved and saved during a previous game session either in the gaming establishment or on a separate computing device at a different location.

Turning now to FIG. 4b, the various components of the gaming machine 410 may be controlled by a central processing unit (CPU) 434, also referred to herein as a controller or processor (such as a microcontroller or microprocessor). The controller 434 may include any suitable processor, such as an Intel® processor, AMD processor, or UltraSPARC processor. To provide gaming functions, the controller 434 may execute (or be physically configured according to) one or more game programs stored in a computer readable storage medium, in the form of a main memory 436. The main memory 436 may include a volatile memory (e.g., a random-access memory (RAM)) and a non-volatile memory (e.g., an EEPROM). The main memory 436 may include multiple RAM and multiple program memories. The main memory 436 may further include a wagering game unit 437. In some embodiments, the wagering game unit 437 may present wagering games having a casino game format, such as video poker, video black jack, video slots, video lottery, reel slots, etc., in whole or in part. Alternatively, the wagering games may be in a casual or social game format, as described in greater detail below.

The controller 434 may perform the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It may be appreciated that the controller 434 may include one or more microprocessors, including but not limited to a master processor, a slave processor, and a secondary or parallel processor.

The controller 434 may also be coupled to a value input device 438. The value input device 438 may signal the processor that money and/or credits have been input via the value input device 418. These components may be located within the housing 412 of the gaming machine 410 or, as explained above, may be located outboard of the housing 412 and connected to the remainder of the components of the gaming machine 410 via a variety of different wired or wireless connection methods.

As seen in FIG. 4b, the controller 434 may be also connected to, and controls, the primary display 414, the player input device 424, a payout mechanism 440, and a storage unit 441. The payout mechanism 440 may be operable in response to instructions from the controller 434 to award a payout to the player in response to certain winning outcomes that might occur in the basic game or the award game(s). The payout may be provided in the form of points, bills, tickets, coupons, cards, etc. For example, in FIG. 4a, the payout mechanism 440 may include both a ticket printer 442 and a coin outlet 444. However, any of a variety of payout mechanisms 440 well known in the art may be implemented, including cards, coins, tickets, smartcards, cash, etc. The payout amounts distributed by the payout mechanism 440 may be determined by one or more pay tables stored in the main memory 436.

An input/output (“I/O”) bus 446 may provide communications between the controller 434 and the peripheral components of the gaming machine. The I/O bus 446 may include any suitable bus technologies, such as an AGTL+ frontside bus and a PCI backside bus. More specifically, the controller 434 may control and receive inputs from the peripheral components of the gaming machine 410 through the I/O bus 446. The I/O bus 446 also may be connected to an external system interface 448, which in turn is connected to external systems 450. The external systems 450 may include a gaming network, other gaming machines, a gaming server, communications hardware, or a variety of other interfaced systems or components. The controller 434 may communicate with the external systems 450 via the external system interface 448 and a communication path (e.g., serial, parallel, IR, RC, 10bT, etc.) The external system interface 448 may include logic for exchanging information over wired and wireless networks (e.g., 802.11g transceiver, Bluetooth transceiver, Ethernet transceiver, etc.). Although the I/O bus 446 and external system interface 448 may be illustrated as single blocks, it should be appreciated that each may include a number of different types of I/O circuits.

The I/O bus 446 further may be connected to a location unit 445. The location unit 445 may create player information that indicates the wagering game machine's location/movements in a casino. In some embodiments, the location unit 445 includes a global positioning system (GPS) receiver that can determine the wagering game machine's location using GPS satellites. In other embodiments, the location unit 445 may include a radio frequency identification (RFID) tag that can determine the wagering game machine's location using RFID readers positioned throughout a casino. Some embodiments can use GPS receivers and RFID tags in combination, while other embodiments may use other suitable methods for determining the wagering game machine's location. Although not shown in FIG. 4b, in some embodiments the location unit 445 is not connected to the I/O bus 446.

In some embodiments, the wagering game machine 410 may include an online gaming module 447. The online gaming module 447 may process communications, commands, or other information, where the processing may control and present online wagering games.

Controller 434, as used herein, may include any combination of hardware, software, and/or firmware that may be disposed or resident inside and/or outside of the gaming machine 410 that may communicate with and/or control the transfer of data between the gaming machine 410 and a bus, another computer, processor, or device and/or a service and/or a network. The controller 434 may include one or more controllers or processors. In FIG. 4b, the controller 434 in the gaming machine 410 is depicted as comprising a CPU, but the controller 434 may alternatively include a CPU in combination with other components, such as the I/O bus 446, the external system interface 448, and the main memory 436. The controller 434 may reside partially or entirely inside or outside of the machine 410. The control system for a handheld gaming machine (disclosed below) may be similar to the control system for the free standing gaming machine 410 except that the functionality of the respective on-board controllers may vary.

### Mobile Gaming Machine

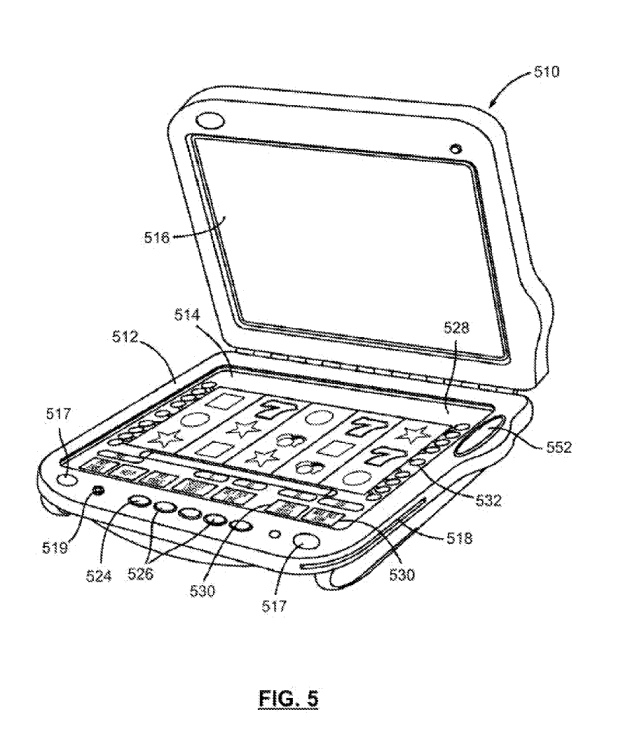

Another type of client 108 may be a handheld or mobile gaming machine 510, illustrated in FIG. 5. Like the free standing gaming machine 410, the handheld gaming machine 510 may be an electronic gaming machine configured to play a casino game such as, but not limited to, slots, keno, poker, blackjack, and roulette. The handheld gaming machine 510 may include a housing or casing 512 and may include input devices, including a value input device 518 and a player input device 524. For output, the handheld gaming machine 510 may include, but is not limited to, a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the handheld gaming machine 510 may include a secondary display 516 that is rotatable relative to the primary display 514. The optional secondary display 516 may be fixed, movable, and/or detachable/attachable relative to the primary display 514. Either the primary display 514 and/or secondary display 516 may be configured to display any aspect of a wagering game, an award game, a progressive wagering game, a group games, a shared-experience game or event, a game event, a game outcome, scrolling information, text messaging, an emails, an alert or announcement, broadcast information, subscription information, and handheld gaming machine status.

The player-accessible value input device 518 may include, for example, a slot located on the front, side, or top of the casing 512 configured to receive credit from a stored-value card (e.g., casino card, smart card, debit card, credit card, etc.) inserted by a player. In another aspect, the player-accessible value input device 518 may include a sensor (e.g., an RF sensor) configured to sense a signal (e.g., an RF signal) output by a transmitter (e.g., an RF transmitter) carried by a player. The player-accessible value input device 518 may also or alternatively include a ticket reader, or barcode scanner, for reading information stored on a credit ticket, a card, or other tangible portable credit or funds storage device. The credit ticket or card may also authorize access to a central account, which may transfer money to the handheld gaming machine 510.

Still other player-accessible value input devices 518 may require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player may be permitted to access a player's account. As one potential optional security feature, the handheld gaming machine 510 may be configured to permit a player to only access an account the player has specifically set up for the handheld gaming machine 510. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 510.

The player-accessible value input device 518 may itself include or utilize a biometric player information reader which permits the player to access available funds on a player's account, either alone or in combination with another of the aforementioned player-accessible value input devices 518. In an embodiment wherein the player-accessible value input device 518 include a biometric player information reader, transactions such as an input of value to the handheld device, a transfer of value from one player account or source to an account associated with the handheld gaming machine 510, or the execution of another transaction, for example, may all be authorized by a biometric reading, which may include a plurality of biometric readings, from the biometric device.

Alternatively, to enhance security, a transaction may be optionally enabled only by a two-step process in which a secondary source confirms the identity indicated by a primary source. For example, a player-accessible value input device 518 may include a biometric player information reader which may require a confirmatory entry from another biometric player information reader 552, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) may be utilized to provide enhanced security prior to the electronic transfer of any funds. In another aspect, the value input device 518 may be provided remotely from the handheld gaming machine 510.

The player input device 524 may include a plurality of push buttons on a button panel for operating the handheld gaming machine 510. In addition, or alternatively, the player input device 524 may include a touch screen 528 mounted to a primary display 514 and/or secondary display 516. In one aspect, the touch screen 528 may be matched to a display screen having one or more selectable touch keys 530 selectable by a user's touching of the associated area of the screen using a finger or a tool, such as a stylus pointer. A player may enable a desired function either by touching the touch screen 528 at an appropriate touch key 530 or by pressing an appropriate push button 526 on the button panel. The touch keys 530 may be used to implement the same functions as push buttons 526. Alternatively, the push buttons may provide inputs for one aspect of the operating the game, while the touch keys 530 may allow for input needed for another aspect of the game. The various components of the handheld gaming machine 510 may be connected directly to, or contained within, the casing 512, as seen in FIG. 5, or may be located outboard of the casing 512 and connected to the casing 512 via a variety of hardwired (tethered) or wireless connection methods. Thus, the handheld gaming machine 510 may include a single unit or a plurality of interconnected parts (e.g., wireless connections) which may be arranged to suit a player's preferences.

The operation of the basic wagering game on the handheld gaming machine 510 may be displayed to the player on the primary display 514. The primary display 514 may also display the award game associated with the basic wagering game. The primary display 514 may take the form of a high resolution LCD, a plasma display, an LED, or any other type of display suitable for use in the handheld gaming machine 510. In some embodiments, the gaming machine 510 may be provided as a portable phone, portable gaming console, or other specific or multi-purpose hand-held device, in which case the primary display 514 may be the display provided with such a device. The size of the primary display 514 may vary from, for example, about a 2-3″ display to a 15″ or 17″ display. In at least some embodiments, the primary display 514 may be a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 514 and/or secondary display 516 may have a 16:9 aspect ratio or other aspect ratio (e.g., 4:3) and the aspect ratio may be modified depending on the game and use of the device. The primary display 514 and/or secondary display 516 may also each have different resolutions, different color schemes, and different aspect ratios.

As with the free standing gaming machine 410, a player may begin play of the basic wagering game on the handheld gaming machine 510 by making a wager (e.g., via the value input device 518 or an assignment of credits stored on the handheld gaming machine via the touch screen keys 530, player input device 524, or buttons 526) on the handheld gaming machine 510. In at least some aspects, the basic game may include a plurality of symbols arranged in an array, and includes at least one payline 532 that indicates one or more outcomes of the basic game. Such outcomes may be randomly selected in response to the wagering input by the player. At least one of the plurality of randomly selected outcomes may be a start-award outcome, which can include any variations of symbols or symbol combinations triggering a award game.

In some embodiments, the player-accessible value input device 518 of the handheld gaming machine 510 may double as a player information reader 552 that allows for identification of a player by reading a card 354 (FIG. 3) with information indicating the player's identity (e.g., reading a player's credit card, player ID card, smart card, etc.). The player information reader 552 may alternatively or also include a bar code scanner, RFID transceiver or computer readable storage medium interface. In one embodiment, the player information reader 552, shown by way of example in FIG. 5, may include a biometric sensing device.

### Gaming System Security

Security features are advantageously utilized where the gaming machines 410, 510 communicate wirelessly with external systems, such as through wireless local area network (WLAN) technologies, wireless personal area networks (WPAN) technologies, wireless metropolitan area network (WMAN) technologies, wireless wide area network (WWAN) technologies, or other wireless network technologies implemented in accord with related standards or protocols (e.g., the Institute of Electrical and Electronics Engineers (IEEE) 802.11 family of WLAN standards, IEEE 802.11i, IEEE 802.11r (under development), IEEE 802.11w (under development), IEEE 802.15.1 (Bluetooth), IEEE 802.12.3, etc.). For example, a WLAN in accord with at least some aspects of the present concepts may include a robust security network (RSN), a wireless security network that allows the creation of robust security network associations (RSNA) using one or more cryptographic techniques, which provides one system to avoid security vulnerabilities associated with IEEE 802.11 (the Wired Equivalent Privacy (WEP) protocol). Constituent components of the RSN may include, for example, stations (STA) (e.g., wireless endpoint devices such as laptops, wireless handheld devices, cellular phones, handheld gaming machine 510, etc.), access points (AP) (e.g., a network device or devices that allow(s) an STA to communicate wirelessly and to connect to a(nother) network, such as a communication device associated with I/O circuit(s) 448), and authentication servers (AS) (e.g., an external system 450), which provide authentication services to STAs. Information regarding security features for wireless networks may be found, for example, in the National Institute of Standards and Technology (NIST), Technology Administration U.S. Department of Commerce, Special Publication (SP) 800-97, ESTABLISHING WIRELESS ROBUST SECURITY NETWORKS: A GUIDE TO IEEE 802.11, and SP 800-48, WIRELESS NETWORK SECURITY: 802.11, BLUETOOTH AND HANDHELD DEVICES, both of which are incorporated herein by reference in their entirety.

### Client Interface—Registration

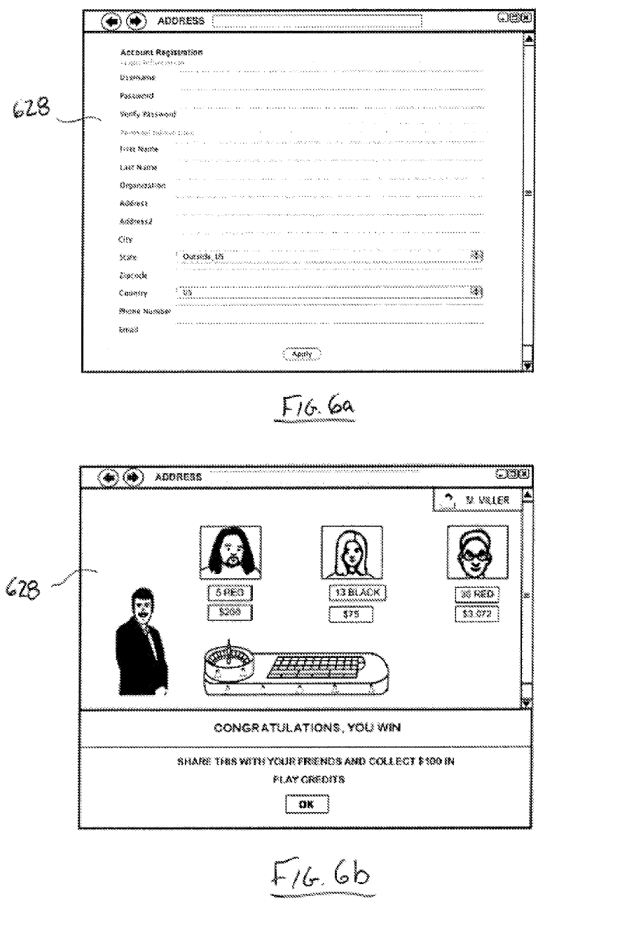

Among other things, the clients 108 may be configured to communicate with the gaming servers 102 to retrieve gaming service data, display gaming service data, operate a gaming service on the client devices 108, and communicate any relevant input provided by the registrant and received through the one or more input devices 118 back to the gaming servers 102. Gaming service data may be initially retrieved from the gaming servers 102 by request of the registrant at the client 108. Specifically, the registrant can initiate the request by navigating a web browser, or the like, within the client device 108 to one or more network or internet addresses associated with and/or managed by the gaming servers 102. Upon receiving the request, the gaming servers 102 communicate gaming service data associated with the desired gaming service through the network 110 to be downloaded, installed and executed on the client device 108. The gaming service data may contain information which once downloaded and installed within the client device 108 creates an interface 628, such as the web-based interface shown in FIGS. 6a and 6b, a standalone application-based interface, or the like, that is supported by the operating system of the client device 108, through which the registrant may participate and/or interact with the gaming service.

The interface 628 provided to the registrant via the client 108 can be configured in a number of different ways to facilitate interactions between the registrant and the gaming service. As shown in FIG. 6a for instance, the interface 628 may be used to receive registration information from a new user so as to register the user with one or more gaming services and to store the registrant information in the database or memory 116 associated with the gaming servers 102. More particularly, the interface 628 may be used to gather information such as the registrant's name, mailing address, contact information, electronic mailing address, and the like. The registration interface 628 may also enable the registrant to establish a desired alias, username or login, as well as corresponding passwords or other login credentials.

### Client Interface—Gameplay

In addition, the interface 628 can be used to enable play of a wagering game or otherwise facilitate registrant participation. As noted above, the wagering game may be a game of chance, a contest, a social (i.e., “play-for-fun”) game, a sweepstake, or other gaming content provided by the gaming servers 102, as shown in FIG. 6b. For example, while displaying images, video, audio, and/or any other media pertaining to play of a wagering game, the interface 628 may also be configured to receive various inputs from the registrant during gameplay. Based on the type of client device 108 being used and the types of input devices 118 available to the player, for example, the player may provide game input using actions such as mouse-clicks, keystrokes, mouse gestures, finger or hand gestures, voice commands, and the like. Such player input is read by the client device 108 and used to determine the corresponding actions and/or selections that are desired by the player. The relevant actions and/or selections can then be communicated to the respective gaming servers 102 in a manner which enables the player to gain entry into contests or sweepstakes, advance through levels or stages of a game of chance, acquire cash-redeemable credits or virtual currency, rewards, points, and the like.

### Player Accounts

Player accounts may be used to store, track, and update information associated with registered players of the wagering game. Each registered player may have an associated player account. For example, a first player account may be associated with a first player, a second player account may be associated with a second player, and so on. Each player account may include account information associated with a respective registered player. In addition to the player information noted above, each player account may include additional information related to play of the wagering game, such as information indicative of an amount of money, virtual currency, or other assets attributed to the player associated with the player account. The assets may be configured for use in the wagering game or other games. For example, the player account may include a real credit balance indicative of real credits available for wagering in a casino-style wagering game, a virtual credit balance indicative of an amount of virtual credits available for wagering in a social/casual type wagering game, and/or other account information that tracks other assets or attributes that may be used in the casino, social/casual, or other type of wagering game. The player accounts may be stored on a remote server, such as the account server 106. Alternatively, the player accounts may be stored locally, such as on a gaming device 410, 510, stationary or portable PC, on-site server (e.g., a casino server), or other computational device 360.

### Critical Data Versioning

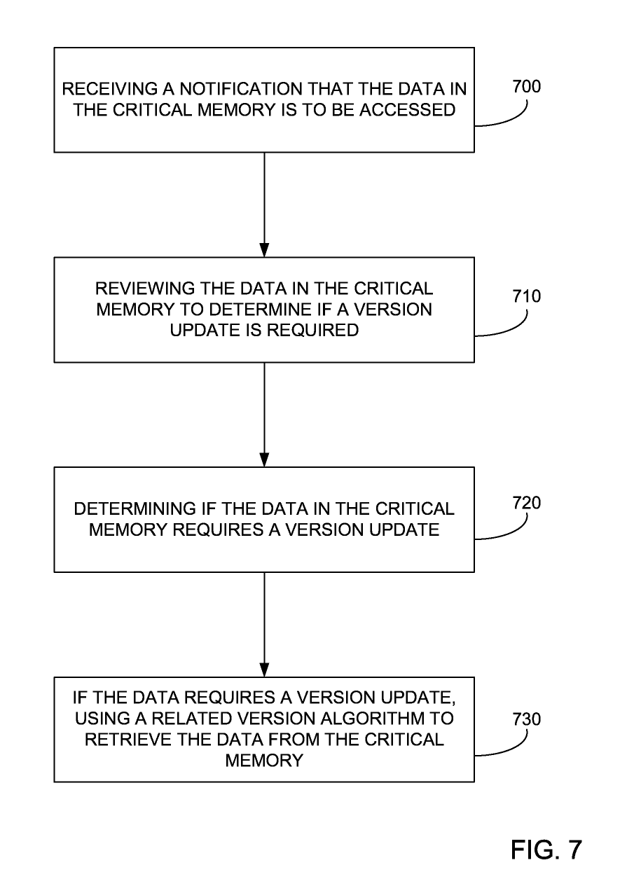

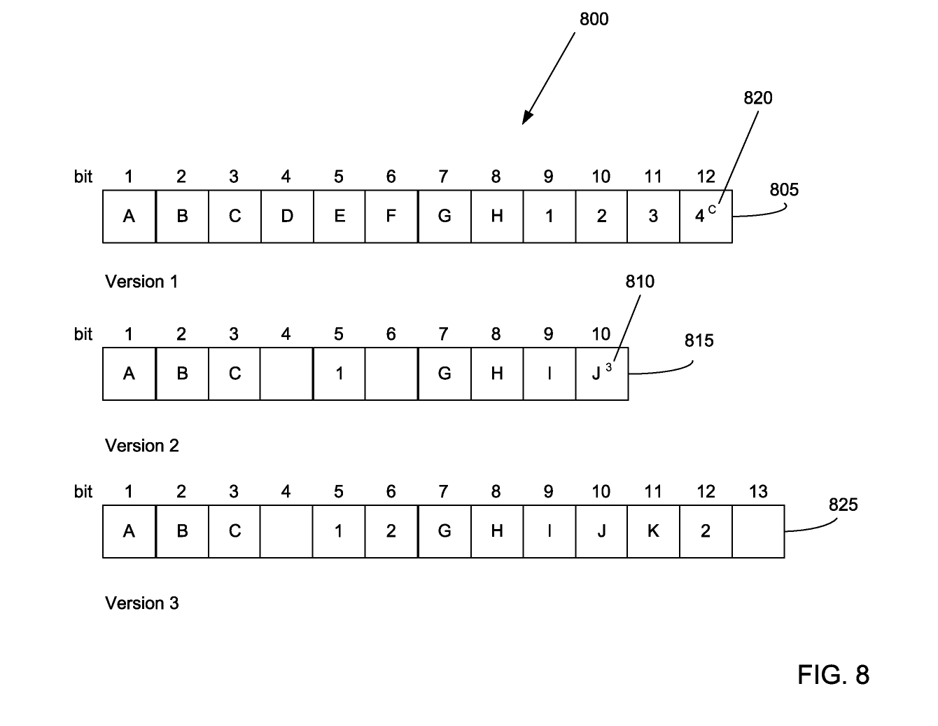

Referring now to FIG. 7, a method of parsing data stored according to a plurality of versions in critical memory in a gaming device, such as the gaming device 410 (FIG. 4) is illustrated. In any gaming environment where the various components of a gaming machine 410 or system may need updating or upgrading throughout its lifecycle, it may be desirable that some or all records from critical memory 800 (FIG. 8) or data be kept around thru an upgrade, and/or moved, copied or otherwise stored outside of the machine 410, or system (perhaps an off-system location). Critical machine memory records 800 could consists of as game play history (game outcome), logs, meters, or configuration parameters such as machine IP address, host or server information or configured devices.

Challenges may appear, such as the data that needs to be kept from an older version of the game to the newer version may have been restructured to include new data or remove unused data. This case is in contrast to a situation where a complete reinstallation can take place whereby all critical data may be allowed to be erased and thus no storage and versioning is needed. When the data is loaded from the non-volatile storage (NVRAM, DISK, SSD), external device (peripheral) or location on the network it must be read back or decoded in the same order otherwise the data integrity or coherence could not be guaranteed.

The described updating of critical data 800 is described in reference to a traditional standalone gaming machine 420 (FIG. 4) but the concepts and details may be easily adapted to virtually any gaming environment, from social gaming to gaming on cell phones. While the contents of the critical data 800 may vary by application, the concept of critical data 800 may be present in virtually all gaming environments. Thus, the description of the gaming machine 420 as being a standalone machine is meant to be exemplary and not limiting in any way.

Referring briefly to FIG. 8, in version1 (805), serializing the first 12 entries, which may be made up of one or more bits or blocks, may result in:
ABCDEFGH1234<end>
   While serializing the first 12 entries of version 2 (815) may result in:
ABC 1 GHIJ <end>
   And serializing the first 12 entries of version 3 (825) may result in:
ABC 12GHIJK2<end>
   The data in Versions 1, 2 and 3 may all represent the same data but due to versioning, serializing the data from an incorrect version without using an update algorithm may result in serious errors.

Referring to FIG. 7, at block 700, a notification that the data in the critical memory 800 is to be accessed may be received. For example, during a game upgrade such as a maintenance upgrade or new features such a new language being supported, a game's pay table configuration may need to be either removed or migrated to a backup location, but the associate history and meters may need to be kept around for regulatory compliance and/or operator requirements to handle player disputes. When such access is request, the notification may occur to ensure the data is properly parsed.

At block 710, the data in the critical memory 800 of the gaming machine 410 may be reviewed to determine if a version update is required. In some embodiments, a versioning hint or value (one implementation could store it in the structure as the version number) 810 (FIG. 8) may be used to dictate and determine the archive algorithm or order used. For example, the version number of 1 may mean the encoding/decoding algorithm or ordering version of 1 may be required, a version number of 2 may mean the encoding/decoding algorithm or ordering version of 2 may be required, etc.

In another embodiment, the critical data 800 may not have a version indication. However, the structure and content of the critical data in the critical memory 800 may be reviewed to determine if a version update may be required. Referring to FIG. 8, version 1 of critical data 805 may be known to have:
eight entries that are expected to be alpha entries (1-8) and
four entries of numeric entries (9-12),
   Version 2 (815) expects to have:
three entries of alpha entries (1-3),
a blank entry (4),
a numeric entry (5),
a blank entry (6) and
four alpha entries (7-10)
   while version 3 (825) is expected to have:
three alpha entries (1-3),
a blank entry (4),
two numeric entries (5-6),
five alpha entries (7-11),
a numeric entry (12) and
a blank entry (13).

By looking at the sixth entry of each version 805, 815, 825, the version in question may be obtained assuming the data is not corrupt. Specifically, at the sixth entry, version 1 (805) should have an alpha entry, version 2 (815) should be a blank entry and version 3 (825) should have a numeric entry. Similarly, the length of the data string in question should provide the version. Specifically, version 1 (805) should be 12 entries of data, version 2 should be 10 entries of data (815) and version 3 (825) should be 13 entries of data. Once the version is determined, then the proper algorithm needed may be found to extract the data in the desired format.

Similarly, a string of data may have a plurality of different versions. For example, in FIG. 8, in version 2 (815), at entry 10, the letter “j” (with the version 3 indication 810) may be known by the proper versioning algorithm to represent the four number combination of “1234” as is listed in entries 9-12 in version 1 (805). Similarly, previous versions of the critical data may also be represented in later versions but in a different form that can be understood and translated by the proper versioning algorithm. Thus, in version 3 (825), entry 5 may be translated from version 2 (815) to version 3 (825) by a first version algorithm and entry 6 may be translated from version 1 (805) to version 3 (825) by a second version algorithm.

As another example of critical data 800, a “CabinetConfig” may contain a set of “GameConfig”. Each “GameConfig” may contain a set of “PaytableConfig”. This is represented in pseudo-code below.

| Struct CabinetConfig //Version 1 | | |
|---|---|---|
| { | set<GameConfig> games; | }; |

| Struct GameConfig //Version 4 | | |
|---|---|---|
| { | set<PaytableConfig> paytables; | }; |

| Struct PaytableConfig //Version 6 | | |
|---|---|---|
| { | string paytableName; | }; |

In this example “paytableName” does not have a version number associated with it even though it is also a complex data structure. A structure may not have an associated version number if it is not believed that the structure is likely to change. In this case, it is assumed that “string” is essentially a fixed type and unlikely to change.

If a single “CabinetConfig” is saved in non-volatile store with M games each containing N paytables, it may not be marked with a single version number. Each structure may be versioned independently. Given the version numbers in the example above, a single CabinetConfig might contain the binary representation of the following layout (version numbers appear in <>'s):

<1>{ <4>{ <6>”G1paytable1”, <6>”G1paytable2”, ...<6>”G1paytableN”
}

<4>{ <6>”G2paytable2”, <6>”G2paytable2”, ...<6>”G2paytableN” }

...

<4>{ <6>”GMpaytable1”, <6>”GMpaytable2”,
...<6>”GMpaytableN” } }

If “GameConfig” is later updated to the following pseudo-code:

| Struct GameConfig //Version 5 | |
|---|---|
| { | string gameName; |
| | set<PaytableConfig> paytables; }; |

Then the single CabinetConfig may have the following layout:

<1>{<5>{ “Game1” <6>”G1paytable1”, <6>”G1paytable2”,
...<6>”G1paytableN” }

```
  <5>{ “Game2” <6>”G2paytable2”, <6>”G2paytable2”,
  ...<6>”G2paytableN” }
```

...

<5>{“GameM”<6>”GMpaytable1”,<6>”GMpaytable2”,
...<6>”GMpaytableN” } }

Notice that “CabinetConfig” did not need to update its version number because it still just contains a set of “GameConfig”. Similarly, “PaytableConfig” didn't need to update its version number.

### Coexistence of Explicit Versioning and Implicit Versioning

Data structures that are versioned to facilitate an upgrade path may also be used in applications where no upgrade is necessary. Because of this co-existence, in some embodiments, there may be differentiation between a versioned archive (data set) and a non-versioned archive.

Version numbers 810 may only be used explicitly when versioned data structures are used within a versioned archive and when a non-versioned archive is used to store the data set, the data is assumed to contain the “latest” version of the data that is known by a given release. Continuing with the CabinetConfig example from above, assume that the CabinetConfig may be used for three distinct purposes:
1. Store an upgradable CabinetConfig in non-volatile memory and it may be desirable to have this data set include all version numbers in the case of an upgrade.
2. Pass the CabinetConfig between a client and a server via Ethernet. It may be desirable to have this data set include all version numbers just in case the server and the client are running different versions of the software.
3. Pass the CabinetConfig from one process to another process on the same node. If it is assume that both processes are part of a single software release, then it may no longer need to pass the version number. It may be assumed that both processes have the same assumption on what the “latest” version of the structures.

Case #1 and #2 from above may use a versioned archive and have a similar layout to what the example described. Case #3 may have a non-versioned archive and may have the following layout (assuming version #5 of GameConfig):

| | |
|---|---|
| { | { “Game1” ”G1paytable1”, ”G1paytable2”, ...”G1paytableN” } |
| | { “Game2” ”G2paytable2”, ”G2paytable2”, ...”G2paytableN” } |

...

{ “GameM” ”GMpaytable1”, ”GMpaytable2”, ...”GMpaytableN” } }

Referring again to FIG. 7, at block 720, it may be determined if the data in the critical memory in the gaming machine 410 requires a version update. Not all changes in version may require a version update. It may be desirable to keep the critical data the same in later versions of an application. Thus, even if a new version of an application is installed, the critical data may remain the same in the later versions. In some other situation, the critical data may have been updated previously and may not need to be updated.

In some embodiments, each entry of data may be versioned meaning some entries may need to be updated while other entries may not need to be updated. In other embodiments, each block in critical memory may have a version indication and some blocks may need to be updated while other block may be left alone. In yet another embodiment, only the entries or blocks that need an update may have an indication such as indication 810 that an update is required. Of course, other embodiments are possible and are contemplated.

At block 730, if the data requires a version update, a related version algorithm may be used to retrieve the data from the critical memory. In some embodiments, the version indication may be used to determine a proper algorithm to be the version algorithm. In other embodiment, the known format of critical data in the various versions may be used to analyze the data to determine the proper algorithm to be used. The algorithm may be a simple mapping of data from one version to another or may be a more sophisticated process such as an encryption type system where an input results in an output that may be much larger than the input.

As mentioned previously, the version indication 810 may reference a first algorithm and the first versioning algorithm may reference a second version algorithm. In this way, the references to the proper algorithms may be nested.

In some embodiments, the version algorithms may be stored locally. In other embodiments, the version algorithms may be stored remotely and may be accessed through a secure wired or wireless network. In yet another embodiment, the version indication 810 stored with the critical data 800 may comprise an algorithm. Thus, the algorithm may be readily accessible for all authorized applications that are attempting to manipulate the critical data.

The version algorithm may be backward and forward compatible with other versions. A reverse or backward compatible method may be if the updated software needs to provide a backwards compatible copy, that is to say that the software may need to provide a method of storing a part of the volatile ram data structure as a version 1 copy by maintaining the algorithm for storing a version 1 based on a version 2 even if it results in loss of fidelity. Logically, if the version indication indicates there is not a new version or analysis of the critical data indicates there are no versioning issues, access the critical memory 800 may be permitted.

An example embodiment may be as follows:

Take an existing configured electronic gaming machine (EGM) 410 with its complete set of configuration data and critical data 800. The EGM 410 may have some programs in place each with their corresponding non-volatile and volatile data sets.

A game or operating system (OS) may be downloaded to the EGM 410. When the new game or OS component loads and the associated new program retrieves a data set from storage (local, peripheral or remote), it may read a version information 810 which hints to the way the data will be interpreted (i.e. data structure). The application may decode (from non-volatile) and place the data in memory in the new organization (new version mapping). When the decoding is complete (or next time the data is saved), the application may write out the data to the non-volatile location 800 in this new organization including the version number 810 associated with the new mapping/data structure of the critical data and any new integrity calculation (such as a checksum or hash).

### Clone-Able

In order to avoid time consuming repetitive steps in configuration of common data such as the system protocol configuration, pay table, or even peripheral devices, the critical data set 800 may be copied from one EGM 410 to another automatically or on behalf of the operator by the software in place. One implementation may have designated access rights or markers to the individual critical data set 800 components. When these rights and designations are observed, it may be possible to allow the data set (entire or partial) to be used in multiple EGMs/machines 410.

It may be assumed that the critical data set 800 that is to be replicated from one EGM 410 to another 410 has been obtained from a “Golden” EGM 410 or a predetermined configuration “Template” and then migrated or replicated and having reached its intended destination of a secondary EGM 410 or component to be configured based on said the critical data set 800. The critical data 800 may also include a clone-able indication 820 (shown as a superscript c in FIG. 8). The clone-able indication 820 may indicate whether some or all of the critical data 800 is appropriate to be cloned to another gaming device 410. For example, an update may be pushed to a first device such as a gaming device 410. The critical data 800 may be properly versioned and stored. The critical data 800 may be a good candidate to be copied into the critical data 800 for additional similar gaming devices 410. Of course, this assumes that the critical data 800 is appropriate to be copied from gaming device 410 to gaming device 410. For example, a pay table may be the same from gaming device 410 to gaming device 410 but payoff records may be inappropriate to be copied from gaming device 410 to gaming device 410 as the payoff record may be gaming device 410 specific and may need to be saved for legal reasons. In some embodiments, the clone-able indication 820 may be communicated to other gaming devices 410 and in other embodiments, the indication 820 may be communicated to a central authority such as server 102.

Further, each upgradable component may have its own associated critical memory or data 800. Each section of critical memory 800 may have its own cloning indication 820 of whether it has been updated and is appropriate to be cloned.

In some embodiments, the updated aspects may be “pushed” or communicated to gaming devices 410 that are not updated. In some additional embodiments, a gaming device 410 that is missing some updates may “pull” the updates from other devices 410 that indicate their critical data 800 is at the proper version. In yet additional embodiments, a central server 102 may “pull” or receive updates from updated gaming devices 410 and may “push” or communicate updates to gaming devices 410 that need the updates.

The following may be some embodiments of sharing clone-able critical data 800.

### Peer to Peer Environment

A peer to peer gaming environment may have a plurality of gaming machine in communication. In some embodiments, there may not be a central computing authority while in other embodiments, there may be a central authority, which may be one of the peers. At block 900, the 1st EGM (on the network) 410 may be powered up and started. It is assumed the critical data 800 is up to date and is indicated 820 as being clone-able.

At block 910, critical data and configuration information 800 that may be stored in persistent storage may be marked/analyzed to determine if it is “CLONEABLE” or not, e.g., the settings/values groups of data may be allowed to be copied to another location or device on node or off node.

As mentioned previously, in some embodiments, a “clone-able configuration” designation 820 may be pre-marked in the application executable or script. In yet another embodiment, the “Clone-able configuration” determination may be entirely or partially allowed to be completed by an operator or remote authority. For example, the operator may pick and choose which data they would like to persist when versions are upgraded.

At block 920, a “clone-able” feature on 1st EGM 410 may be started. The start may be triggered by a signal after an update, may be from an operator or may be based on a periodic check. At block 930, an “I'm Clone-able” message may be broadcast to all other EGMs 410. An example may be that EGM 410 has Zeus, pay table, configuration info, etc. The broadcast may accomplished by the EGM 410 publishing a list of clone-able features or the actual NVRAM files/data. The broadcast could be a simple advertisement of clone data set meta data (i.e. —the EGM 420 announces it has game data, meters, etc.)

At block 940, EGM's 410 in maintenance mode (with door open & logic box open) may note that the broadcast of “I'm Clone-able” has been received. The EGM 410 may decide on its own whether to review the broadcast or an operator may decide to review the broadcast. The decision to review the broadcast may be based on a variety of factors such as time of day, period since last review, criticality of the update, current use, etc. The factors may be weighted and scored to determine if the update should be reviewed.

At block 950, cloning options may be reviewed. The EGM 410 may decide some updates to critical memory 800 may take too long and may save those for a later date while other may be installed. In an alternative embodiment, the decision may be made by an operator (i.e. what settings to use/match).

At block 960, the EGM 410 CPU may performs a sanity check. The sanity check may ensure the broadcast files will work on the EGM 410 in question (i.e. does the 1^{st} EGM 410 have the same printer, games, etc.). The settings and data may be actual NVRAM files/data or structure messages containing the data.

At block 970, if the sanity check of block 960 is passed, the EGM 410 CPU may provide those games & options it has loaded that match the available updates.

At block 980, the EGM 410 CPU may provide the option of obtaining and installing the critical memory 800 update. In some embodiments, an authority may decide whether to install the update. In a simple example, the authority may be an individual. In another embodiment, the decision may be analyzed by an application that weights and scores several factors to determine if the update should be installed. Some of the factors may include the importance of the update, how out of date the current critical data is, the impact of the update, the current level of gameplay, etc. If the decision is yes, the update may be installed.

### Master or Server Proxy:

Updates using a master or server proxy may be accomplished similarly except that each machine may communicate its basic data to the master (1st) EGM 420 in the peer-to-peer (P2P) network and 1st EGM 420 may acts as the configuration Master/Server. An application or operator may configure the critical data in all the EGMs 420 from the “master” EGM 420.

### True Server Environment:

A wide area or bank level server/controller, such as server 102, may be used to distribute the updates. A “thin client interface” may be on the 1st EGM 420 admin but may be delivered via HTTP or some other protocol.

### Secondary or Peripheral Device:

The updates to critical data 800 may also be delivered to EGMs 420 according to other options including a configuration device such as a USB memory key, or an USB data bridge between EGMs 420 where the configuration files are transferred to a configuration device and then transported to the 2nd EGM 420 for replication based on access rights.

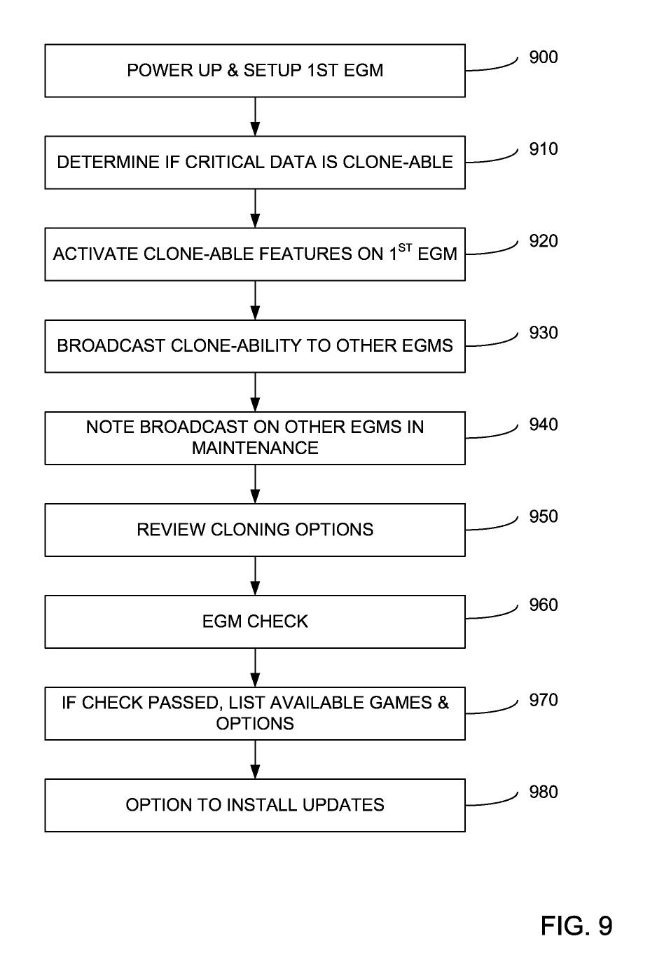

FIGS. 7 and 9, described by way of example above, represent one algorithm that corresponds to at least some instructions executed by the CPU 30 in FIG. 2 to perform the above described functions associated with the disclosed concepts. Each of these embodiments and obvious variations thereof is contemplated as falling within the spirit and scope of the following claims. Moreover, the present concepts expressly include any and all combinations and sub-combinations of the proceeding elements and aspects.

In accordance with the provisions of the patent statutes and jurisprudence, exemplary configurations described above are considered to represent a preferred embodiment of the disclosure. However, it should be noted that the disclosure can be practiced otherwise than as specifically illustrated and described without departing from its spirit or scope.

1. A method of parsing data stored according to a plurality of versions in critical memory in a processor based gaming device comprising:
receiving a notification at an input/output circuit that the data in the critical memory is to be accessed;
reviewing the data in the critical memory to determine if a version update is required;
determining if the data in the critical memory requires a version update; and
if the data requires a version update, using a related version algorithm operating on a processor to retrieve the data from the critical memory.

2. The method of claim 1, wherein the data comprises a version indication that represents the version of the data.

3. The method of claim 2, further comprising using the version indication to determine a proper algorithm to be the version algorithm.

4. The method of claim 2, wherein the version algorithm comprises instructions for accessing data that is appropriate for the version of the critical memory.

5. The method of claim 2, further comprising if the version indication indicates there is not a new version, proceeding to access the critical memory.

6. The method of claim 2, wherein each entry in critical memory has a version indication.

7. The method of claim 2, wherein each block in critical memory has a version indication.

8. The method of claim 2, wherein a version indication is attached to entries that require an update.

9. The method of claim 1, wherein reviewing the data in the critical memory to determine if a version update is required further comprises:
reviewing the structure and content of the critical data;
determining the version of the critical data based on the structure and content of the critical data;
determining if a version algorithm is needed to parse the critical data; and
if a version algorithm is needed, determining the proper version data based on the structure and content of the data.

10. The method of claim 9, wherein the critical data is reviewed to determine if there is a plurality of data versions in the critical data.

11. The method of claim 10, wherein there are a plurality of data versions, using a plurality of version algorithms to parse the data.

12. The method of claim 11, wherein version indications and reviewing the structure and content of the critical data are used to determine the one or more version algorithms that are require to parse the critical data.

13. The method of claim 1, wherein the critical data further comprises a clone-able indication wherein the clone-able indication indicates whether some or all of the critical data is appropriate to be cloned to another device.

14. The method of claim 13, wherein the clone-able indication is communicated to additional computing devices determined to be appropriate to replace the critical data on the additional computing device.

15. A computing system comprising a processor physically configured according to computer executable instructions for parsing data stored according to a plurality of versions in critical memory in a gaming device, a memory physically configured to store computer executable instructions and an input/output circuit, the computer executable code comprises instructions for:
receiving at the input/output circuit a notification that the data in the critical memory is to be accessed;
reviewing the data in the critical memory to determine if a version update is required;
determining if the data in the critical memory requires a version update; and
if the data requires a version update, using a related version algorithm operating on the processor to retrieve the data from the critical memory.

16. The computer system of claim 15, wherein reviewing the data in the critical memory to determine if a version update is required further comprises computer executable code for:
reviewing the structure and content of the critical data;
determining the version of the critical data based on the structure and content of the critical data;
determining if a version algorithm is needed to parse the critical data; and
if a version algorithm is needed, determining the proper version data based on the structure and content of the data.

17. The computer system of claim 16, wherein the critical data is reviewed to determine if there is a plurality of data versions in the critical data, and wherein there is a plurality of data versions, using a plurality of version algorithms to parse the data.

18. A non-transitory computer storage medium physically configured according to computer executable instructions for parsing data stored according to a plurality of versions in critical memory in a gaming device, the computer executable code comprises instructions for:
receiving a notification at an input-output circuit that the data in the critical memory is to be accessed;
reviewing the data in the critical memory to determine if a version update is required;
determining if the data in the critical memory requires a version update; and
if the data requires a version update, using a related version algorithm on a processor to retrieve the data from the critical memory.

19. The computer storage medium of claim 18, wherein reviewing the data in the critical memory to determine if a version update is required further comprises:
reviewing the structure and content of the critical data;
determining the version of the critical data based on the structure and content of the critical data;
determining if a version algorithm is needed to parse the critical data; and
if a version algorithm is needed, determining the proper version data based on the structure and content of the data.

20. The computer storage medium of claim 19, wherein the critical data is reviewed to determine if there is a plurality of data versions in the critical data, and wherein there is a plurality of data versions, using a plurality of version algorithms to parse the data.
